(19) United States
(12) Patent Application Publication
(10) Pub. No.: US 2012/0324898 A1
(43) Pub. Date: Dec. 27, 2012

(54) COMBUSTOR ASSEMBLY FOR USE IN A TURBINE ENGINE AND METHODS OF ASSEMBLING SAME

(76) Inventors: Kevin Weston McMahan, Greer, SC (US); Ronald James Chila, Greer, SC (US); David Richard Johns, Simpsonville, SC (US)

(21) Appl. No.: 13/164,948

(22) Filed: Jun. 21, 2011

(51) Int. Cl. F23R 3/02; B21D 53/00; F02C 3/00

(52) U.S. Cl. 60/752; 29/890.02

(57) ABSTRACT

A combustor assembly for use with a turbine engine that includes a rotor assembly. The combustor assembly includes a casing that includes a plenum and a combustor liner that is spaced a distance from the plenum and that defines a combustion chamber therein. A transition nozzle extends between the combustor liner and the rotor assembly for channeling combustion gases from the combustion chamber to the rotor assembly. The transition nozzle includes a transition portion and a nozzle portion integrally formed with the transition portion. An annular flowsleeve is coupled radially outward from the transition nozzle such that an annular flow path is defined between the flowsleeve and the transition nozzle. The flowsleeve includes a plurality of openings extending through an outer surface of the flowsleeve for providing flow communication between the plenum and the annular flow path to facilitate impingement cooling of the flowsleeve.

### BACKGROUND OF THE INVENTION

The subject matter described herein relates generally to turbine engines and more particularly, to combustor assemblies for use with turbine engines.

At least some known gas turbine engines ignite a fuel-air mixture in a combustor assembly to generate a combustion gas stream that is channeled to a turbine via a hot gas path. Compressed air is delivered to the combustor assembly from a compressor. Known combustor assemblies include a combustor liner that defines a combustion region, and that includes a plurality of fuel nozzles that facilitate fuel and air delivery to the combustion region, and a transition piece that channels the combustion gas stream from the combustion region to the turbine. The turbine converts the thermal energy of the combustion gas stream to mechanical energy used to rotate a turbine shaft. The output of the turbine may be used to power a machine, for example, an electric generator or a pump.

At least some known gas turbine engines use cooling air to cool the combustor assembly. Often the cooling air is supplied from the compressor. More specifically, in at least some known turbine engines, cooling air is discharged from the compressor into a plenum that extends at least partially around the combustor liner and the transition piece of the combustor assembly. Known combustor assemblies also include a sleeve that circumscribes the combustor liner such that a cooling channel is defined between the sleeve and the combustor liner. Air entering the plenum is channeled across an outer surface of the transition piece and into the cooling channel defined between the combustor liner and the cooling sleeve. Cooling air entering the cooling channel is discharged upstream towards the fuel nozzles for use in generating combustion gases.

Cooling air flowing through the plenum cools an exterior of the transition piece. The plenum channels the cooling air in a non-uniform air flow pattern across the outer surface of the transition piece. However, the non-uniform flow distribution may induce temperature variations across the transition piece outer surface and may cause an uneven heat transfer between the transition piece and the cooling air. Overtime, such an uneven heat transfer may result in thermal cracking and/or damage to the transition piece, both of which may reduce the overall useful life of the transition piece and/or increase the cost of maintaining and operating the turbine engine.

### BRIEF DESCRIPTION OF THE INVENTION

In one aspect, a combustor assembly for use with a turbine engine that includes a rotor assembly is provided. The combustor assembly includes a casing that includes a plenum and a combustor liner that is spaced a distance from the plenum and that defines a combustion chamber therein. A transition nozzle extends between the combustor liner and the rotor assembly for channeling combustion gases from the combustion chamber to the rotor assembly. The transition nozzle includes a transition portion and a nozzle portion integrally formed with the transition portion. An annular flowsleeve is coupled radially outward from the transition nozzle such that an annular flow path is defined between the flowsleeve and the transition nozzle. The flowsleeve includes a plurality of openings extending through an outer surface of the flowsleeve for providing flow communication between the plenum and the annular flow path to facilitate impingement cooling of the flowsleeve.

In another aspect, a turbine engine is provided. The turbine engine includes a rotor assembly and a combustor in flow communication with the rotor assembly for channeling a flow of combustion gases to the rotor assembly. The combustor includes a plurality of combustor assemblies. At least one of the combustor assemblies includes a casing that includes a plenum and a combustor liner that is spaced a distance from the plenum and that defines a combustion chamber therein. A transition nozzle extends between the combustor liner and the rotor assembly for channeling combustion gases from the combustion chamber to the rotor assembly. The transition nozzle includes a transition portion and a nozzle portion integrally formed with the transition portion. An annular flowsleeve is coupled radially outward from the transition nozzle such that an annular flow path is defined between the flowsleeve and the transition nozzle. The flowsleeve includes a plurality of openings that extend through an outer surface of the flowsleeve for providing flow communication between the plenum and the annular flow path to facilitate impingement cooling of the flowsleeve.

In a further aspect, a method of fabricating a combustor assembly for use in a turbine engine is provided. The method includes coupling a combustor liner assembly to a casing such that the combustion liner is positioned within the casing and such that a combustion chamber is defined within the combustion liner. A transition nozzle is integrally formed including a transition portion and a nozzle portion. The transition nozzle is coupled to the combustor liner for channeling combustion gases from the combustion chamber to a rotor assembly. An annular flowsleeve is formed including an inner surface that is oriented obliquely with respect to the rotor assembly. A plurality of openings are defined through the flowsleeve inner surface to facilitate impingement cooling of the flowsleeve. The annular flowsleeve is coupled radially outwardly from the transition nozzle such that an annular flow path is defined between the flowsleeve and the transition nozzle.

### BRIEF DESCRIPTION OF THE DRAWINGS

FIG. 1 is a schematic illustration of an exemplary turbine engine.

FIG. 2 is a schematic illustration of an exemplary combustor section that may be used with the turbine engine shown in FIG. 1.

FIG. 3 is an enlarged cross-sectional illustration of a portion of an exemplary combustor assembly used with the combustor section shown in FIG. 2.

FIG. 4 is a schematic view of a portion of the combustor assembly shown in FIG. 3 and taken along line 4-4.

### DETAILED DESCRIPTION OF THE INVENTION

The exemplary methods and systems described herein overcome at least some disadvantages of known combustor assemblies by providing a flowsleeve that discharges a substantially uniform flow distribution of cooling fluid about a transition nozzle to facilitate enhanced heat transfer between the cooling fluid and the transition nozzle outer surface. In addition, the transition nozzle described herein channels combustion gases tangentially with respect to a rotor assembly to facilitate increasing an amount of rotational force imparted to the rotor assembly from the combustion gases. Moreover, the flowsleeve includes an inner surface that is oriented obliquely with respect to the rotor assembly to enable a flow of cooling fluid having a uniform distribution to be distributed about the transition nozzle outer surface. In addition, the flowsleeve described herein includes a plurality of circumferentially-spaced openings that channel the cooling fluid towards the transition nozzle outer surface to facilitate impingement cooling of the transition nozzle. The uniform distribution of cooling fluid facilitates substantially evenly reducing a temperature of the transition nozzle outer surface, which facilitates increasing the operating life of the combustor liner.

As used herein, the term “upstream” refers to a forward end of a turbine engine, and the term “downstream” refers to an aft end of a turbine engine.

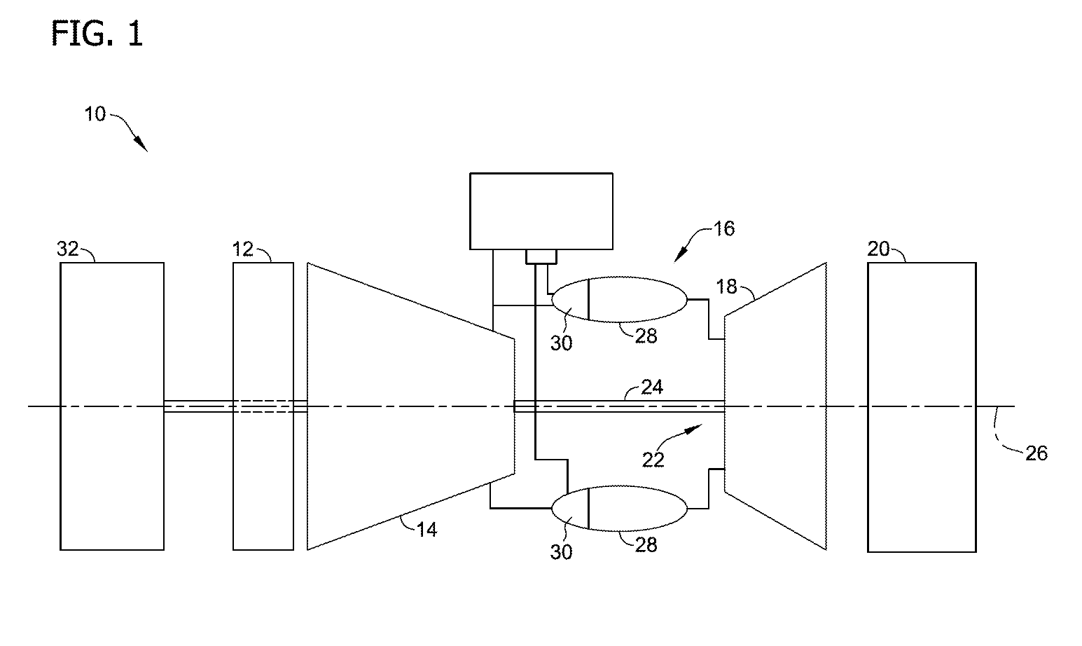

FIG. 1 is a schematic view of an exemplary turbine engine 10. Turbine engine 10 includes an intake section 12, a compressor section 14 that is downstream from intake section 12, a combustor section 16 downstream from compressor section 14, a turbine section 18 downstream from combustor section 16, and an exhaust section 20 downstream from turbine section 18. Turbine section 18 is coupled to compressor section 14 via a rotor assembly 22 that includes a shaft 24 that extends along a centerline axis 26. Combustor section 16 includes a plurality of combustor assemblies 28 that are each coupled in flow communication with the compressor section 14. A fuel nozzle assembly 30 is coupled to each combustor assembly 28. Turbine section 18 is rotatably coupled to compressor section 14 and to a load 32 such as, but not limited to, an electrical generator and/or a mechanical drive application.

During operation, air flows through compressor section 14 and compressed air is discharged into combustor section 16. Combustor assembly 28 injects fuel, for example, natural gas and/or fuel oil, into the air flow, ignites the fuel-air mixture to expand the fuel-air mixture through combustion, and generates high temperature combustion gases. Combustion gases are discharged from combustor assembly 28 towards turbine section 18 wherein thermal energy in the gases is converted to mechanical rotational energy. Combustion gases impart rotational energy to turbine section 18 and to rotor assembly 22, which subsequently provides rotational power to compressor section 14.

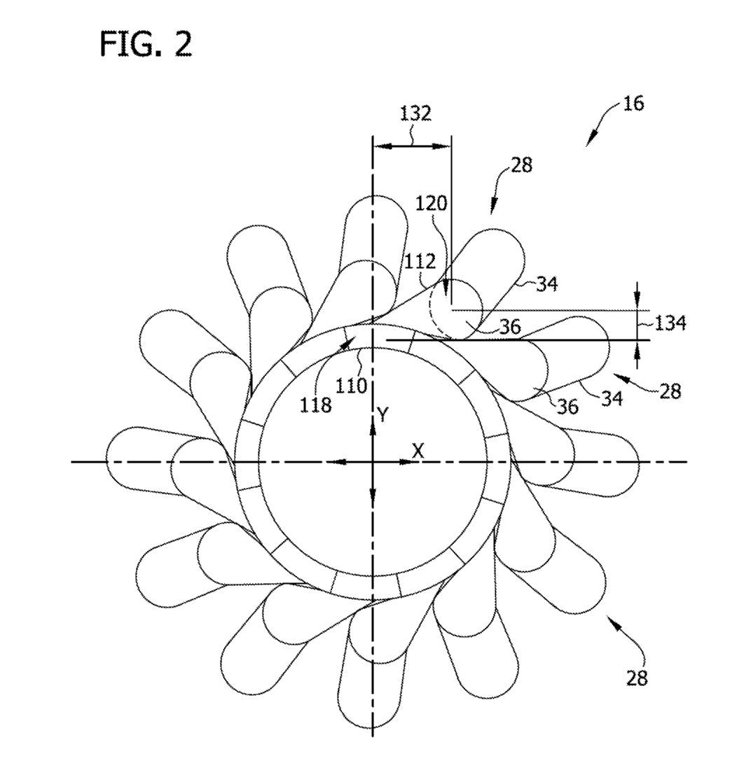

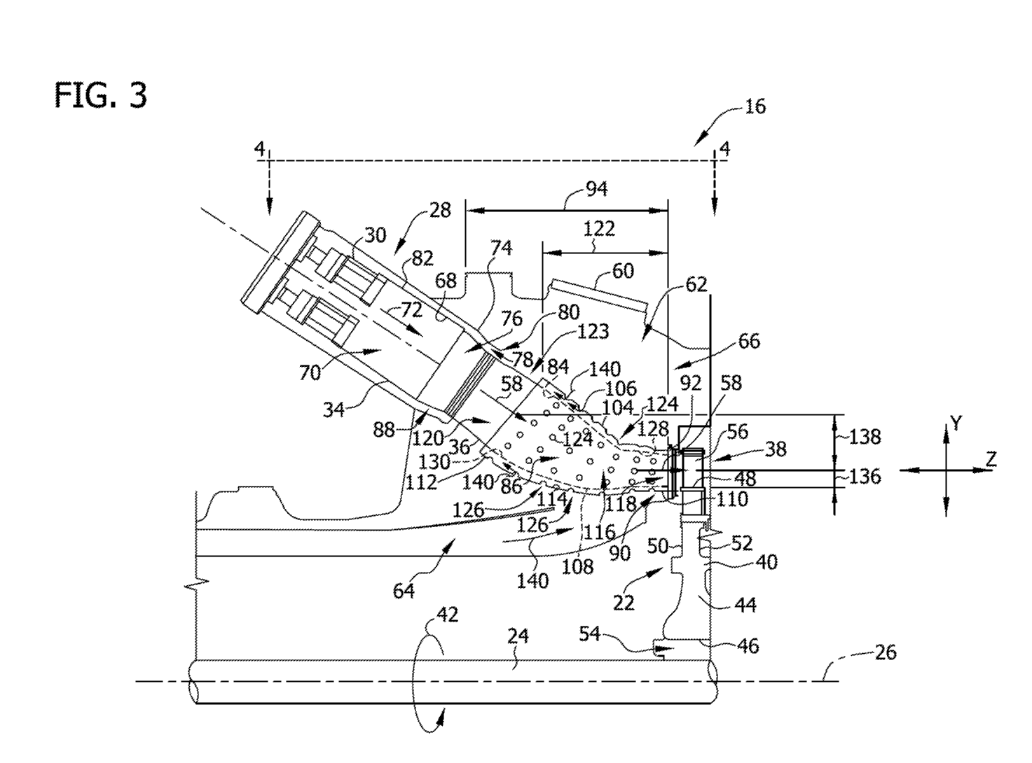

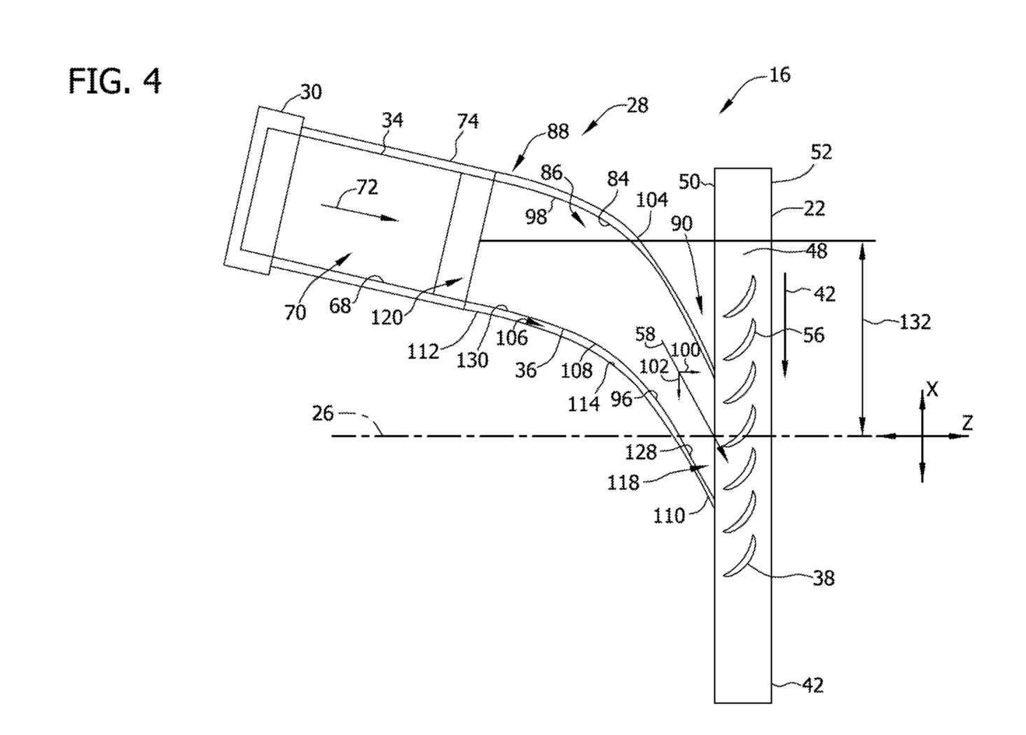

FIG. 2 is a schematic illustration of combustor section 16. FIG. 3 is an enlarged cross-sectional illustration of a portion of combustor section 16. FIG. 4 is a schematic view of a portion of combustor assembly 28 along line 4-4 shown in FIG. 3. In the exemplary embodiment, combustor section 16 includes a plurality of combustor assemblies 28 that are circumferentially-spaced about rotor assembly 22. Each combustor assembly 28 includes a combustor liner 34 and a transition nozzle 36. Combustor liner 34 is coupled to fuel nozzle assembly 30, and transition nozzle 36 is coupled between combustor liner 34 and rotor assembly 22 to channel combustion gases from combustor liner 34 to rotor assembly 22.

Rotor assembly 22 includes a plurality of turbine buckets 38 that each extend radially outward from a plurality of rotor disks 40. Each rotor disk 40 is coupled to drive shaft 24 and rotates about drive shaft centerline axis 26. Rotor assembly 22 rotates about centerline axis 26 in a rotational direction 42. Each rotor disk 40 includes an annular disk body 44 that is oriented substantially perpendicularly to centerline axis 26. Disk body 44 extends radially between a radially inner surface 46 and a radially outer surface 48, and axially from an upstream surface 50 to an opposite downstream surface 52. Radially inner surface 46 defines a central bore 54 that extends substantially axially through disk body 44. Upstream surface 50 and downstream surface 52 each extend between inner surface 46 and outer surface 48. Each turbine bucket 38 is coupled to disk outer surface 48 and is spaced circumferentially about rotor disk 40. Each turbine bucket 38 includes an airfoil 56 that extends radially outwardly from disk body 44.

In the exemplary embodiment, combustor assembly 28 channels combustion gases, represented by arrow 58, towards rotor assembly 22 such that combustion gases 58 that are discharged from combustor assembly 28 are oriented obliquely with respect to rotor assembly 22. Moreover, combustor assembly 28 channels combustion gases 58 generally along rotational direction 42. Discharging combustion gases 58 obliquely with respect to rotor assembly 22 facilitates increasing an amount of rotational energy imparted to rotor assembly 22 from combustion gases 58 by increasing an amount of surface area of turbine bucket 38 that is contacted by combustion gases 58.

Combustor section 16 also includes a casing 60 that defines a chamber 62 therein. Moreover, compressor section 14 includes a diffuser 64 that is coupled in flow communication with chamber 62 to channel compressed air downstream from compressor section 14 to chamber 62. A plenum 66 is defined within chamber 62. Each combustor assembly 28 is positioned within chamber 62 and is coupled in flow communication with turbine section 18 and with compressor section 14.

In the exemplary embodiment, combustor liner 34 includes a substantially cylindrically-shaped inner surface 68 that defines an annular combustion chamber 70 therein. Combustor liner 34 is coupled to fuel nozzle assembly 30 such that fuel nozzle assembly 30 channels fuel into combustion chamber 70. Combustion chamber 70 defines a combustion gas flow path 72 that extends from fuel nozzle assembly 30 to turbine section 18.

A combustor sleeve 74 is coupled to casing 60 and includes a cavity 76 that is sized and shaped to receive combustor liner 34 and fuel nozzle assembly 30 therein. Combustor sleeve 74 is coupled radially outwardly from combustor liner 34 such that an annular passage 78 is defined between combustor sleeve 74 and combustor liner 34. Combustor sleeve 74 includes an inlet opening 80 that defines a flow path into passage 78. Passage 78 is sized and shaped to channel air from plenum 66 towards fuel nozzle assembly 30 for use in generating combustion gases 58, and to channel an airflow across an outer surface 82 of combustor liner 34 to facilitate cooling combustor liner 34 via a transfer of heat between outer surface 82 and the airflow.

Transition nozzle 36 is coupled to combustor liner 34 to channel combustion gases 58 from combustor liner 34 to turbine section 18. Transition nozzle 36 includes an inner surface 84 that defines a guide cavity 86 that channels combustion gases 58 from combustion chamber 70 downstream towards rotor assembly 22. Inner surface 84 extends between a transition portion 88 and a nozzle portion 90 such that guide cavity 86 is defined between transition portion 88 and nozzle portion 90. Transition portion 88 is integrally formed with nozzle portion 90 such that transition nozzle 36 is formed as a single, or unitary, component. Transition portion 88 is coupled to combustor liner 34 such that combustion chamber 70 is in flow communication with guide cavity 86, and such that combustion chamber 70 and guide cavity 86 are substantially isolated from plenum 66. Nozzle portion 90 extends from transition portion 88 and is positioned adjacent turbine section 18 to enable guide cavity 86 to channel combustion gases 58 from combustor liner 34 to rotor assembly 22. Nozzle portion 90 includes a transition nozzle frame 92 that is coupled to casing 60 and that is positioned adjacent to turbine section 18. Transition nozzle 36 is coupled between combustor liner 34 and rotor assembly 22 and has a length 94 extending from combustor liner 34 to rotor assembly 22.

In the exemplary embodiment, nozzle portion 90 includes an inner surface 96 that is oriented obliquely with respect to disk upstream surface 50. Transition portion 88 includes an inner surface 98 that is oriented obliquely with respect to inner surface 96. Moreover, transition nozzle 36 is configured to discharge combustion gases 58, characterized with an axial flow vector, represented by arrow 100, along centerline axis 26, and with a tangential flow vector, represented by arrow 102, that is oriented tangentially with respect to disk radially outer surface 48.

In the exemplary embodiment, combustor assembly 28 includes a flowsleeve 104 that is coupled to transition nozzle 36 and that is spaced radially outwardly from transition nozzle 36 such that an annular flow path 106 is defined between transition nozzle 36 and flowsleeve 104. Flow path 106 is sized and shaped to channel air from plenum 66 across an outer surface 108 of transition nozzle 36 to facilitate cooling transition nozzle 36 via a transfer of heat between outer surface 108 and the airflow. Flowsleeve 104 includes a forward portion 110 and an aft portion 112 that extends outwardly from forward portion 110. Flowsleeve 104 also includes an inner surface 114 that defines a cavity 116 that extends between a forward opening 118 defined by forward portion 110 and an aft opening 120 defined by aft portion 112.

Transition nozzle 36 is positioned within cavity 116 such that flowsleeve inner surface 114 substantially circumscribes transition nozzle outer surface 108. Aft portion 112 is coupled to transition nozzle frame 92 to support flowsleeve 104 from transition nozzle 36. Flowsleeve 104 extends outwardly from transition nozzle frame 92 and includes a length 122 defined between aft portion 112 and forward portion 110. In the exemplary embodiment, flowsleeve length 122 is less than transition nozzle length 94. Alternatively, flowsleeve length 122 may be greater than, or equal to, length 94. In the exemplary embodiment, flowsleeve 104 is oriented such that a gap 123 is defined between flowsleeve 104 and combustor sleeve 74. Aft opening 120 is configured to provide flow communication between plenum 66 and flow path 106. In one embodiment, flowsleeve 104 may be coupled to combustor sleeve 74 such that flowsleeve 104 extends between combustor sleeve 74 and transition nozzle frame 92.

In the exemplary embodiment, flowsleeve 104 includes a plurality of openings 124 that extend through inner surface 114 and provide flow communication between plenum 66 and flow path 106. Each opening 124 is sized and shaped to channel air from plenum 66 towards flow path 106 to facilitate reducing a temperature of transition nozzle 36. In the exemplary embodiment, each opening 124 discharges a jet of air from plenum 66 towards outer surface 108 to facilitate impingement cooling of transition nozzle 36. In one embodiment, flowsleeve 104 includes a plurality of axially-spaced rows 126, that each include a plurality of circumferentially-spaced openings 124, that are oriented about flowsleeve.

Axes X, Y, and Z each extend substantially perpendicularly through flowsleeve forward opening 118 to define a three-dimensional Cartesian coordinate system that is oriented such that the Z-axis is aligned substantially parallel with centerline axis 26, and such that the X-axis is aligned substantially tangentially with respect to disk outer surface 48. In the exemplary embodiment, forward portion 110 is oriented obliquely with respect to rotor assembly 22. Moreover, forward portion 110 includes an inner surface 128 that is oriented obliquely with respect to disk upstream surface 50 in the X-Z plane, and is oriented substantially parallel with respect to disk radially outer surface 48 in the Y-Z plane. Aft portion 112 is oriented with respect to forward portion 110 such that an inner surface 130 of aft portion 112 is oriented obliquely with respect to forward portion inner surface 128 in the X-Z plane, and is oriented obliquely with respect to forward portion inner surface 128 in the Y-Z plane. In the exemplary embodiment, flowsleeve 104 is oriented such that forward opening 118 is offset a circumferential distance 132 along the X-axis from aft opening 120, and forward opening 118 is offset a radial distance 134 along the Y-axis from aft opening 120. Forward opening 118 is positioned a first radial distance 136 from disk outer surface 48, and aft opening 120 is positioned a second radial distance 138 from disk outer surface 48 that is greater than first radial distance 136.

In the exemplary embodiment, transition nozzle 36 is oriented such that nozzle portion 90 is oriented obliquely with respect to disk upstream surface 50 in the X-Z plane, and is oriented substantially parallel with respect to disk radially outer surface 48 in the Y-Z plane. Transition portion 88 is oriented obliquely with respect to nozzle portion 90 in the X-Z plane, and transition portion 88 is oriented obliquely with respect to nozzle portion 90 in the Y-Z plane.

During operation, compressor section 14 discharges pressurized compressed air 140 into plenum 66. At least a portion of compressed air 140 within plenum 66 is channeled into cooling flow path 106 through flowsleeve openings 124 to facilitate impingement cooling of transition nozzle 36. Air 140 entering flow path 106 is then discharged from flow path 106 to passage 78 and towards fuel nozzle assembly 30. Air 140 is then mixed with fuel discharged from fuel nozzle assembly 30 and ignited within combustion chamber 70 to form a combustion gas stream 58. Combustion gases 58 are channeled from combustion chamber 70 through transition nozzle guide cavity 86 towards rotor assembly 22. Transition nozzle 36 discharges combustion gases 58 obliquely with respect to rotor assembly 22, and oriented with respect to rotational direction 42 such that combustion gases 58 are characterized as having axial flow vector 100 and tangential flow vector 102.

The orientation of flowsleeve inner surface 114 with respect to rotor assembly 22 is selected to facilitate a substantially uniform flow distribution of cooling fluid between flowsleeve 104 and transition nozzle 36. In addition, the orientation, size, and shape of openings 124 is selected to facilitate impingement cooling of transition nozzle outer surface 108. The uniform cooling flow distribution facilitates enhancing heat transfer between transition nozzle 36 and the cooling fluid channeled through flow path 106, and facilitates reducing damage to transition nozzle 36 caused by uneven cooling of transition nozzle outer surface 108.

The above-described apparatus and methods overcome at least some disadvantages of known combustor assemblies by providing a flowsleeve that discharges a substantially uniform flow distribution of cooling fluid about a transition nozzle to facilitate enhanced heat transfer between the cooling fluid and the transition nozzle outer surface. In addition, a substantially uniform flow distribution about the transition nozzle is facilitated to be increased. In addition, the embodiments described herein facilitate uniformly reducing a temperature across an outer surface of the transition nozzle by providing a plurality of circumferentially-spaced openings that channel a jet of air towards the outer surface, which facilitates increasing the operating life of the transition nozzle. As such, the cost of maintaining the gas turbine engine system is facilitated to be reduced.

Exemplary embodiments of a combustor assembly for use in a turbine engine and methods for assembling the same are described above in detail. The methods and apparatus are not limited to the specific embodiments described herein, but rather, components of systems and/or steps of the method may be utilized independently and separately from other components and/or steps described herein. For example, the methods and apparatus may also be used in combination with other combustion systems and methods, and are not limited to practice with only the turbine engine assembly as described herein. Rather, the exemplary embodiment can be implemented and utilized in connection with many other combustion system applications.

Although specific features of various embodiments of the invention may be shown in some drawings and not in others, this is for convenience only. Moreover, references to “one embodiment” in the above description are not intended to be interpreted as excluding the existence of additional embodiments that also incorporate the recited features. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A combustor assembly for use with a turbine engine that includes a rotor assembly, said combustor assembly comprising:
a casing comprising a plenum;
a combustor liner spaced a distance from said plenum and defining a combustion chamber therein;
a transition nozzle extending between said combustor liner and the rotor assembly for channeling combustion gases from said combustion chamber to the rotor assembly, said transition nozzle comprising a transition portion and a nozzle portion integrally formed with the transition portion; and
an annular flowsleeve coupled radially outward from said transition nozzle such that an annular flow path is defined between said flowsleeve and said transition nozzle, said flowsleeve comprising a plurality of openings extending through an outer surface of said flowsleeve for providing flow communication between said plenum and said annular flow path to facilitate impingement cooling of said flowsleeve.

2. A combustor assembly in accordance with claim 1, wherein said flowsleeve further comprises a forward portion and an aft portion extending from said forward portion, said forward portion comprising an inner surface that is oriented obliquely with respect to the rotor assembly.

3. A combustor assembly in accordance with claim 2, wherein said forward portion inner surface is oriented substantially parallel with respect to a radially outer surface of the rotor assembly.

4. A combustor assembly in accordance with claim 3, wherein said aft portion comprises an inner surface that is oriented obliquely with respect to said forward portion inner surface.

5. A combustor assembly in accordance with claim 1, wherein said flowsleeve extends between a forward opening and an aft opening, said forward opening is offset a circumferential distance from said aft opening.

6. A combustor assembly in accordance with claim 5, wherein said forward opening is positioned a first radial distance from rotor assembly, said aft opening is positioned a second radial distance from the rotor assembly that is greater than the first radial distance.

7. A combustion assembly in accordance with claim 1, wherein each opening of said plurality of openings is configured to discharge a jet of air from the plenum to an outer surface of said transition nozzle to facilitate impingement cooling of said transition nozzle.

8. A combustor assembly in accordance with claim 1, wherein said transition nozzle extends a first length defined between said combustor liner and the rotor assembly, said flowsleeve extends a second length defined between said forward portion and said aft portion that is less than the first length.

9. A turbine engine comprising:
a rotor assembly; and
a combustor in flow communication with said rotor assembly for channeling a flow of combustion gases to said rotor assembly, said combustor comprising a plurality of combustor assemblies, at least one of said combustor assemblies comprising:
a casing comprising a plenum;
a combustor liner spaced a distance from said plenum and defining a combustion chamber therein;
a transition nozzle extending between said combustor liner and said rotor assembly for channeling combustion gases from said combustion chamber to said rotor assembly, said transition nozzle comprising a transition portion and a nozzle portion integrally formed with the transition portion; and
an annular flowsleeve coupled radially outward from said transition nozzle such that an annular flow path is defined between said flowsleeve and said transition nozzle, said flowsleeve comprising a plurality of openings extending through an outer surface of said flowsleeve for providing flow communication between said plenum and said annular flow path to facilitate impingement cooling of said flowsleeve.

10. A turbine engine in accordance with claim 9, wherein said flowsleeve further comprises a forward portion and an aft portion extending from said forward portion, said forward portion comprising an inner surface that is oriented obliquely with respect to the rotor assembly.

11. A turbine engine in accordance with claim 10, wherein said forward portion inner surface oriented substantially parallel with respect to a radially outer surface of said rotor assembly.

12. A turbine engine in accordance with claim 11, wherein said aft portion comprises an inner surface that is oriented obliquely with respect to said forward portion inner surface.

13. A turbine engine in accordance with claim 9, wherein said flowsleeve extends between a forward opening and an aft opening, said forward opening is offset a circumferential distance from said aft opening.

14. A turbine engine in accordance with claim 13, wherein said forward opening is positioned a first radial distance from rotor assembly, said aft opening is positioned a second radial distance from the rotor assembly that is greater than the first radial distance.

15. A turbine engine in accordance with claim 9, wherein each opening of said plurality of openings is configured to discharge a jet of air from the plenum to an outer surface of said transition nozzle to facilitate impingement cooling of said transition nozzle.

16. A turbine engine in accordance with claim 9, wherein said transition nozzle extends a first length defined between said combustor liner and said rotor assembly, said flowsleeve extends a second length defined between said forward portion and said aft portion that is less than the first length.

17. A method of assembling a combustor assembly for use in a turbine engine, said method comprising:
coupling a combustor liner assembly to a casing such that the combustion liner is positioned within the casing and such that a combustion chamber is defined within the combustion liner;
integrally forming a transition nozzle including a transition portion and a nozzle portion;
coupling the transition nozzle to the combustor liner for channeling combustion gases from the combustion chamber to a rotor assembly;
forming an annular flowsleeve including an inner surface that is oriented obliquely with respect to the rotor assembly;
defining a plurality of openings through the flowsleeve inner surface to facilitate impingement cooling of the flowsleeve; and
coupling the annular flowsleeve radially outwardly from the transition nozzle such that an annular flow path is defined between the flowsleeve and the transition nozzle.

18. A method in accordance with claim 17, further comprising forming the flowsleeve sidewall including a forward portion and an aft portion extending from the forward portion, the forward portion including an inner surface that is oriented obliquely with respect to the rotor assembly.

19. A method in accordance with claim 18, further comprising forming the forward portion including a forward opening and forming the aft portion including an aft opening offset a circumferential distance from the forward opening.

20. A method in accordance with claim 18, wherein the transition nozzle extends a first length defined between the combustor liner and the rotor assembly, said method further comprises forming the flowsleeve including a second length defined between the forward portion and the aft portion that is less than the first length.
